(19) United States
(12) Patent Application Publication
(10) Pub. No.: US 2018/0199414 A1
(43) Pub. Date: Jul. 12, 2018

(54) SMART LIGHTING DEVICE, CONTROL TERMINAL, AND LIGHTING SYSTEM

(71) Applicant: SENGLED OPTOELECTRONICS CO., LTD., Tongxiang (CN)

(72) Inventors: JIANBING ZHENG, Tongxiang (CN); JINXIANG SHEN, Tongxiang (CN)

(21) Appl. No.: 15/109,103

(22) PCT Filed: Jan. 19, 2016
(86) PCT No.: PCT/CN2016/071373

§ 371 Date: Jun. 29, 2016

(30) Foreign Application Priority Data
Jan. 22, 2015 (CN) 2015-10031841.3

(51) Int. Cl. H05B 37/02

(52) U.S. Cl. CPC H05B 37/0272; H05B 37/0281

(57) ABSTRACT

A smart lighting device, control terminal, and lighting system are provided. The control terminal includes an input unit configured for receiving at least two control instructions and an execution order of the at least two control instructions, a processing unit connected for encapsulating the at least two control instructions into a control instruction set, and a radiofrequency unit connected for transmitting the control instruction set to the at least one smart lighting device. The smart lighting device includes a radiofrequency unit configured for receiving a control instruction set sent by a control terminal, a processing unit connected for parsing the control instruction set to obtain at least two control instructions and an execution order of the at least two control instructions, a cache unit connected for caching the at least two control instructions, and a lighting module configured to control lighting according to the at least two control instructions.

### CROSS-REFERENCES TO RELATED APPLICATIONS

This PCT patent application claims priority of Chinese Patent Application No. 201510031841.3, filed on Jan. 22, 2015, the entire content of which is incorporated by reference herein.

### TECHNICAL FIELD

The disclosed subject matter generally relates to the lighting technologies and, more particularly, relates to a smart lighting device, a related control terminal, and a related lighting system.

### BACKGROUND

With continuous development of smart home technology, remote controlling is widely used in home lighting. At present, wireless communication devices are usually used for smart lighting control in a lighting system. A control terminal and one or more smart lighting devices can be connected to internet. A user can send control instructions from the control terminal via internet to the one or more smart lighting devices, and the one or more smart lighting devices can be controlled according to each control instruction.

However, due to some network performance problems, such as data loss, data corruption, packet delay variation, insufficient bandwidth, network congestion, etc., a control instruction transmitted over internet may have a certain delay. In these situations, a smart lighting device may need to be under a continuous control, but may not be able to receive control instructions timely in a sequence. For example, a reception time interval between two adjacent control instructions is too long to make the control smooth. So a timeliness of the control terminal to the one or more smart lighting devices can be an issue.

Accordingly, it is desirable to provide a smart lighting device, a related control terminal, and a related lighting system.

### BRIEF SUMMARY

In accordance with some embodiments of the disclosed subject matter, a smart lighting device, a related control terminal, and a related lighting system are provided.

An aspect of the present disclosure provides a control terminal. The control terminal includes an input unit configured for receiving at least two control instructions and an execution order of the at least two control instructions, a processing unit connected with the input unit for encapsulating the at least two control instructions into a control instruction set, and a radiofrequency unit connected with the processing unit for transmitting the control instruction set to the at least one smart lighting device. Each of the at least two control instructions is used to instruct and control at least one smart lighting device. The control instruction set includes the at least two control instructions and information of an execution order of the at least two control instructions.

Optionally, the input unit is configured to receive the at least two control instructions from user's sequential inputs; and the execution order of the at least two control instructions is an order of the user's sequential inputs.

Optionally, the execution order of the at least two control instructions is determined by a time sequence for performing the at least two control instructions.

Optionally, a memory unit is configured for storing at least one control effect that corresponds to the at least two control instructions used to control the at least one smart lighting device to provide a lighting effect corresponding to the at least one control effect.

Optionally, the input unit is further configured for: receiving a user input indicating a control effect stored in the memory unit; and determining the at least two control instructions, and the execution order of the at least two control instructions based on the control effect.

Optionally, the radiofrequency (RF) unit includes a transmitter and a modulation circuit. The modulation circuit is configured for modulating the control instruction set based on a preset modulation scheme to obtain a modulated control signal, and the transmitter is connected with the modulation circuit for transmitting the modulated control signal wirelessly to the at least one smart lighting device.

Another aspect of the present disclosure provides an smart lighting device. The smart lighting device includes a radiofrequency unit configured for receiving a control instruction set sent by a control terminal, a processing unit, connected with the radiofrequency unit for parsing the control instruction set to obtain at least two control instructions and an execution order of the at least two control instructions, a cache unit connected with the processing unit for caching the at least two control instructions, and a lighting module connected with the cache unit and configured to control lighting according to the at least two control instructions. The processing unit is configured to sequentially send the at least two control instructions to the cache unit according to the execution order, and the cache unit is further configured to send the at least two control instructions in a first-in first-out order to the lighting module.

Optionally, the cache unit is further configured to send the at least two control instructions one after another in the first-in first-out order at a preset time interval to the lighting module.

Optionally, the processing unit is further configured to generate a clock according to execution time points in the at least two control instructions, a clock edge of the clock is aligned with an execution time point, and the cache unit is further configured for sending a control instruction to the lighting module in the first-in first-out order upon an upcoming clock edge of the clock.

Optionally, the radiofrequency unit includes a receiver and a demodulation circuit. The receiver is configured for receiving a modulation signal transmitted wirelessly from the control terminal, and the demodulation circuit is connected with the receiver for demodulating the modulation signal to obtain a control instruction set corresponding to the at least two control instructions.

Another aspect of the present disclosure provides a lighting system. The lighting system includes at least one control terminal and at least one smart lighting device.

Optionally, the at least one control terminal is at least one of a mobile phone, a personal digital assistant, a personal computer, a home gateway, a wireless modems, a set-top box, a data card, and a wireless router.

Other aspects of the present disclosure can be understood by those skilled in the art in light of the description, the claims, and the drawings of the present disclosure.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements. It should be noted that the following drawings are merely examples for illustrative purposes according to various disclosed embodiments and are not intended to limit the scope of the present disclosure.

FIG. 1 is a schematic structural diagram of a control terminal in accordance with some embodiments of the disclosed subject matter;

FIG. 2 is a schematic structural diagram of another control terminal in accordance with some embodiments of the disclosed subject matter;

FIG. 3 is a schematic structural diagram of a smart lighting device in accordance with some embodiments of the disclosed subject matter;

FIG. 4 is a schematic structural diagram of another smart lighting device in accordance with some embodiments of the disclosed subject matter; and

FIG. 5 is a schematic structural diagram of a lighting system in accordance with some embodiments of the disclosed subject matter.

### DETAILED DESCRIPTION

For those skilled in the art to better understand the technical solution of the disclosed subject matter, reference will now be made in detail to exemplary embodiments of the disclosed subject matter, which are illustrated in the accompanying drawings. Wherever possible, the same reference numbers will be used throughout the drawings to refer to the same or like parts.

In accordance with various embodiments, the disclosed subject matter provides a smart lighting device, a related control terminal, and a related lighting system.

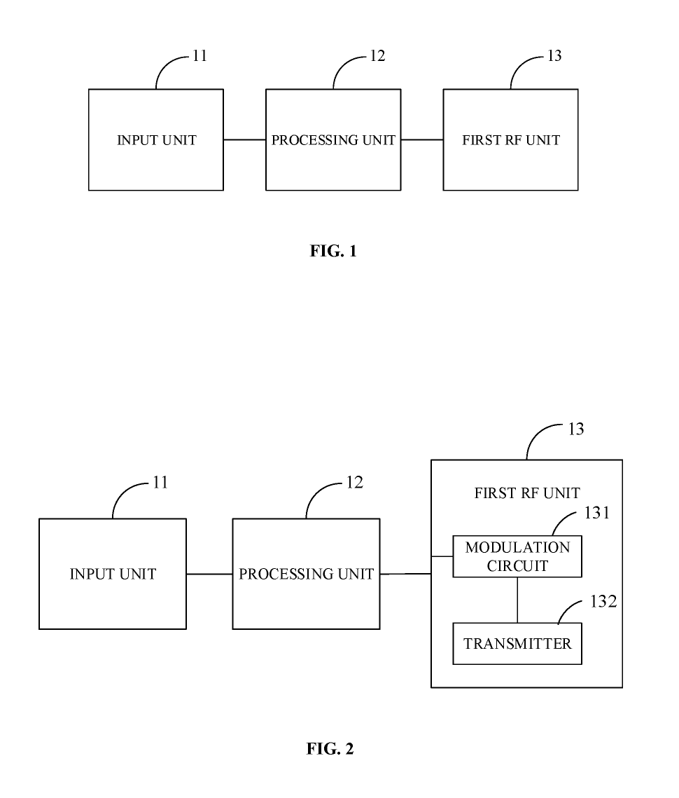

Turning to FIG. 1, a schematic structural diagram of a control terminal is shown in accordance with some embodiments of the disclosed subject matter. A control terminal can be any suitable control device, such as a mobile phone, a personal digital assistant, a personal computer, a home gateway, a wireless modems, a set-top box, a data card, a wireless router, etc. As illustrated, in some embodiments, the control terminal can include input unit 11, processing unit 12, and first radiofrequency (RF) unit 13.

Input unit 11 is configured for receiving at least two control instructions, and an execution order of the at least two control instructions. A control instruction is used to instruct and control one or more smart lighting devices, for example, to control an on/off status for lighting, to control a lighting brightness, to control a lighting color, to control a lighting pattern, etc.

In some embodiments, input unit 11 is specifically configured to receive at least two control instructions from user's sequential inputs. In this case, an order of the user's sequential inputs of the at least two control instructions can be configured as an execution order of the at least two control instructions.

For example, a user can sequentially input three control instructions via input unit 11 to instruct the smart lighting device to switch on, to adjust a brightness to about 50%, and to set a red color for lighting.

In some embodiments, the execution order of the at least two control instructions can include a time sequence to perform the at least two control instructions.

In some embodiments, the control terminal can further include a memory unit (not illustrated). Multiple control effects can be pre-stored in the memory unit of the control terminal. Each control effect can correspond to one or more control instructions that can be performed by the one or more smart lighting devices to achieve a lighting effect corresponding to the control effect.

When input unit 11 receives a user input indicating a control effect stored in the memory unit of the control terminal, input unit 11 can determine at least two control instructions corresponding to the control effect, and execution time points of the at least two control instructions.

For example, a user wants to control a smart lighting device to gradually increase brightness, a control effect of “gradient bright” can be chosen by the user. Based on the user input indicating the control effect of “gradient bright”, control unit 11 can determine a series of control instructions that can control the smart lighting device to increase the brightness by about 10% for every 20 milliseconds. For example, a first control instruction is to set a brightness of about 10% of a maximum brightness of the smart lighting device at a first time point of 0 ms, a second control instruction is to set the brightness of about 20% at a second time point of about 20 ms, a third control instruction is to set the brightness of about 30% at a third time point of about 40 ms, a fourth control instruction is to set the brightness of about 40% at a fourth time point of about 60 ms, a fifth control instruction is setting a luminance of 50% at a fifth time point of about 80 ms, a sixth control instruction is to set the brightness of about 60% at a sixth time point of about 100 ms, a seventh control instruction is to set the brightness of about 70% at a seventh time point of about 120 ms, an eighth control instruction is to set the brightness of about 80% at an eighth time point of about 140 ms, a ninth control instruction is to set the brightness of about 90% at a ninth time point of about 160 ms, and a tenth control instruction is to set the brightness of about 100% of the maximum brightness of the smart lighting device at a tenth time point of about 180 ms.

It should be noted that the above described percentage (e.g., 10%, 20%, 30%, . . . , 100%) is used to describe a brightness level of the smart lighting device and is determined by a ratio of a current brightness of the smart lighting device over a maximum brightness of this smart lighting device.

In other embodiments, a user-specified control effect can be processed to obtain a series of control instructions based on a particular algorithm. Specifically, for a user-specified control effect, the disclosed control terminal can process a simulation for the one or more smart lighting devices to obtain a control state of the one or more smart lighting devices on each time point. For each time point and corresponding to each control state, a control instruction may then be generated.

For example, a user may want to realize a control effect that a lighting combination of a ball room is changing coordinately with a music being played. The disclosed control terminal can simulate lighting of each of smart lighting devices in the ball room based on music being played to obtain a series of control states of each of smart lighting devices in the ball room at multiple time points. Based on the simulation results, a series of corresponding control instructions can be generated by the control terminal, such as input unit 11.

Processing unit 12 is connected with input unit 11. Processing unit 12 can encapsulate the at least two control instructions received from input unit 11 to form a control instruction set.

The control instruction set can include the at least two control instructions, and an execution order of the at least two control instructions.

First RF unit 13 is connected with processing unit 12. Frist RF unit 13 can transmit control instructions and/or the control instruction set to the one or more smart lighting devices.

As disclosed herein, a control terminal can be used to encapsulate at least two control instructions into a control instruction set, and send the control instruction set to one or more smart lighting devices. The smart lighting device can parse the received control instruction set to obtain the at least two control instructions and an execution order of the at least two control instructions. In accordance with the execution order, the at least two control instructions can be executed and controlled one after another by the smart lighting device. Because the control instruction set is used to transmit the at least two control instructions simultaneously, control timeliness problems, occurred when the control terminal controls the smart lighting device and due to the network congestion and the too-long reception time interval between adjacent control instructions long interval, can be solved.

Turning to FIG. 2, a schematic structural diagram of another control terminal is provided in accordance with some embodiments of the disclosed subject matter.

As illustrated, first RF unit 13 can further include transmitter 131 and modulation circuit 132.

Modulation circuit 132 can modulate the control instruction set based on a preset modulation scheme to obtain a modulated control signal.

Transmitter 131 is connected with modulation circuit 132. Transmitter 131 can wirelessly transmit the modulated control signal to the one or more smart lighting devices.

In order to ensure a long distance signal transmission, the frequency spectrum of a control signal can be modulated for transmission in a high-frequency spectrum channel. Thus, the modulation process may load a signal to-be-sent to be a single with high frequency. A control signal can be an analog signal or a digital signal. A modulation can include amplitude modulation (AM), frequency modulation (FM), and phase modulation.

As disclosed herein, a control terminal can be used to encapsulate at least two control instructions into a control instruction set, and send the control instruction set to one or more smart lighting devices. The smart lighting device can parse the received control instruction set to obtain the at least two control instructions and an execution order of the at least two control instructions. In accordance with the execution order, the at least two control instructions can be executed and controlled one after another by the smart lighting device. Because the control instruction set is used to transmit the at least two control instructions simultaneously, control timeliness problems, occurred when the control terminal controls the smart lighting device and due to the network congestion and the too-long reception time interval between adjacent control instructions long interval, can be solved.

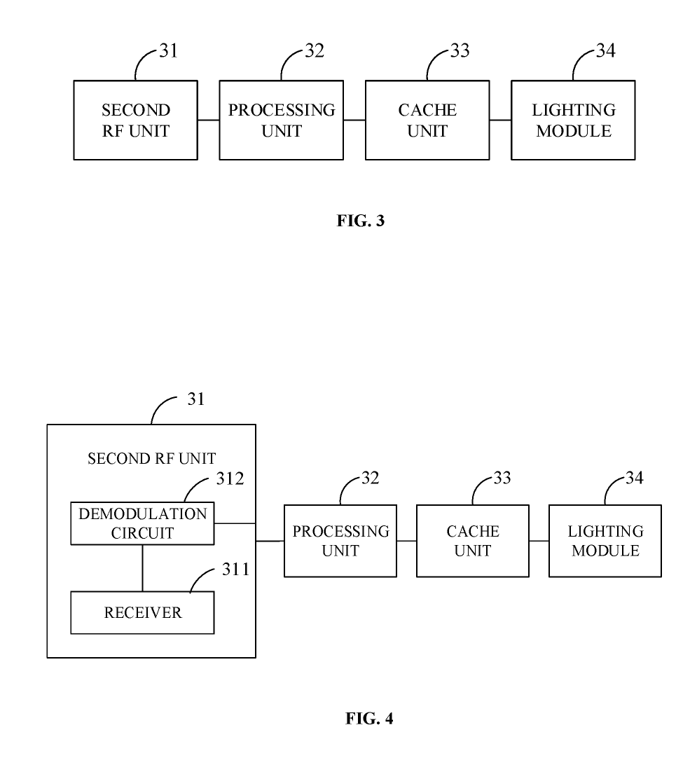

Turning to FIG. 3, a schematic structural diagram of a smart lighting device is shown in accordance with some embodiments of the disclosed subject matter.

As illustrated, a smart lighting device can include second RF unit 31, processing unit 32, cache unit 33, and lighting module 34.

Second RF unit 31 can be configured to receive a control instruction set sent by a control terminal.

Processing unit 32 is connected with second RF unit 31. Processing unit 32 can parse the control instruction set to obtain at least two control instructions, as well as an execution order of the at least two control instructions. Processing unit 32 can also send the at least two control instructions sequentially, according to the execution order, to cache unit 33.

Cache unit 33 is connected with processing unit 32. Cache unit 33 can temporarily store or cache the at least two control instructions received from processing unit 32, and send each of the at least two control instructions one after another to lighting module 34 in accordance with the execution order.

In some embodiments, cache unit 33 can send the cached at least two control instructions one after another to the lighting module 34 in a first-in first-out (FIFO) order at pre-set time interval(s).

Alternatively and optionally, the control instruction may include an execution time point. Accordingly, processing unit 32 can be configured to generate a clock according to the execution time points included in the at least two control instructions. The clock edge of the clock may be aligned with the execution time points for executing each of the at least two control instructions. Upon an upcoming clock edge of each clock, cache unit 33 can be configured to send a cached control instruction to the lighting module in a first-in first-out (FIFO) order.

By using cache unit 33 in the smart lighting device to temporary store or cache the at least two control instructions, the at least two control instructions can be sequentially executed to allow the one or more smart lighting devices to achieve a smooth alteration of lighting effect.

Lighting module 34 is connected with cache unit 33. Lighting module 34 can perform different lighting functions and control the lighting according to a received control instruction from cache unit 33. Lighting module 34 can include one or more lighting components, such as light-emitting diodes (LEDs), color filters, optical lens, polarization films, or any other suitable components.

As disclosed herein, a control terminal can be used to encapsulate at least two control instructions into a control instruction set, and send the control instruction set to one or more smart lighting devices. The smart lighting device can parse the received control instruction set to obtain the at least two control instructions and an execution order of the at least two control instructions. In accordance with the execution order, the at least two control instructions can be executed and controlled one after another by the smart lighting device. Because the control instruction set is used to transmit the at least two control instructions simultaneously, control timeliness problems, occurred when the control terminal controls the smart lighting device and due to the network congestion and the too-long reception time interval between adjacent control instructions long interval, can be solved.

Turning to FIG. 4, a schematic structural diagram of another smart lighting device is shown in accordance with some embodiments of the disclosed subject matter.

Based on the exemplary smart lighting device illustrated in FIG. 3, second RF unit 31 in the smart lighting device in FIG. 4 can include receiver 311 and demodulation circuit 312.

Receiver 311 can receive a modulation signal transmitted wirelessly from a control terminal, e.g., as described above in connection with FIGS. 1 and 2.

Demodulation circuit 312 is connected with receiver 311. Demodulation circuit 312 can be configured to demodulate the received modulation signal to obtain a control instruction set corresponding to the modulation signal. The demodulation can be performed in a preset demodulation scheme, such as a specific mode for AM, FM, or phase modulation.

In order to ensure a long distance signal transmission, the frequency spectrum of a control signal can be modulated for transmission in a high-frequency spectrum channel. Thus, the modulation process may load a signal to-be-sent to be a single with high frequency. A control signal can be an analog signal or a digital signal. A modulation can include amplitude modulation (AM), frequency modulation (FM), and phase modulation. At the receiving end, the modulation signal may be demodulated according to the AM, FM, and phase modulation.

As disclosed herein, a control terminal can be used to encapsulate at least two control instructions into a control instruction set, and send the control instruction set to one or more smart lighting devices. The smart lighting device can parse the received control instruction set to obtain the at least two control instructions and an execution order of the at least two control instructions. In accordance with the execution order, the at least two control instructions can be executed and controlled one after another by the smart lighting device. Because the control instruction set is used to transmit the at least two control instructions simultaneously, control timeliness problems, occurred when the control terminal controls the smart lighting device and due to the network congestion and the too-long reception time interval between adjacent control instructions long interval, can be solved.

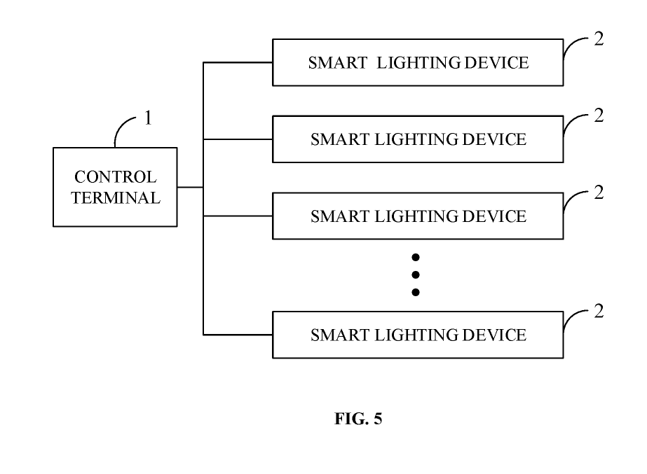

Turning to FIG. 5, a schematic structural diagram of a lighting system is shown in accordance with some embodiments of the disclosed subject matter.

As illustrated, a disclosed lighting system can include at least one control terminal 1 and at least one smart lighting device 2. The control terminal 1 may be, for example, the control terminal in FIGS. 1 and 2, and the smart lighting device 2 may be, for example, the smart lighting device in FIGS. 3 and 4.

Control terminal 1 can be in any suitable form including, for example, a mobile phone, a personal digital assistant, a personal computer, a home gateway, a wireless modems, a set-top box, a data card, a wireless router, etc.

In some embodiments, the lighting system can include multiple smart lighting devices 2. The multiple smart lighting devices 2 may have a same identity (ID), or may have different IDs.

In some embodiments, an application (APP) for user to select and/or input one or more control instructions and/or control effects can be pre-installed in the control terminal 1. The APP in control terminal 1 can broadcast a same control instruction set to multiple smart lighting devices 2 synchronously. The APP in control terminal 1 can also send different control instruction sets to multiple smart lighting devices 2 synchronously and respectively.

According to the one or more control instruction sets sent from the one or more control terminals 1, the multiple smart lighting devices 2 can perform different lighting functions respectively, and a combination of lighting alterations of the multiple smart lighting devices 2 can provide various lighting effects.

For example, multiple smart lighting devices 2 can be arranged in a circle, and a control terminal 1 can send each of the multiple smart lighting devices 2 respective control instruction set to control lighting alteration of the multiple smart lighting devices 2 using the APP software on the control terminal 1 to provide a merry-go-round lighting effect.

As another example, the multiple smart lighting device 2 can provide a color-changing lighting effect corresponding to a music being played.

As disclosed herein, a control terminal can be used to encapsulate at least two control instructions into a control instruction set, and send the control instruction set to one or more smart lighting devices. The smart lighting device can parse the received control instruction set to obtain the at least two control instructions and an execution order of the at least two control instructions. In accordance with the execution order, the at least two control instructions can be executed and controlled one after another by the smart lighting device. Because the control instruction set is used to transmit the at least two control instructions simultaneously, control timeliness problems, occurred when the control terminal controls the smart lighting device and due to the network congestion and the too-long reception time interval between adjacent control instructions long interval, can be solved.

As such, lighting effect may be achieved by adjusting the emitted light of each smart lighting device, such that brightness, color, and/or color temperature of the emitted light of the smart lighting device(s) are adjusted to create different visual, lighting effects.

The smart lighting devices may be controlled in places as desired, e.g., in an open area, a building, or any suitable indoor/outdoor places. The smart lighting devices can be controlled individually or as a group, each being controlled with corresponding lighting effect(s), in response to the control instruction set(s) from control terminal(s).

One or more control terminals may be included in the lighting system to control one or more smart lighting devices. For example, each control terminal installed with application software may use an interface thereon to control one or a group of smart lighting devices.

By control of the control terminal(s), each smart lighting device may be used to accommodate various user needs. In one example, control terminal(s) may be used to control smart lighting device(s) located in a building near the street and also to control smart lighting device(s) located in an open area near the street opposite to the building. Smart lighting device(s) on both sides of the street may be controlled to provide different or same lighting effects and/or to coordinate with one another to provide specific lighting effects.

In another example, the brightness of the emitted light from some smart lighting device(s) may be dimmed, while the color and the color temperature of the emitted light from other smart lighting device(s) may be adjusted to provide a combined lighting effect.

In an additional example, the color of the emitted light from some smart lighting device(s) may be controlled to be green, while the color of the emitted light from other smart lighting device(s) may be controlled to be red to provide a combined lighting effect.

The smart lighting devices may be controlled to provide lighting effect according to changes in an environment. For example, the control terminal(s) and/or the smart lighting device(s) may include a voice and/or video acquisition unit configured to locally collect and obtain audio/video information. Based on the audio/video information, control instructions and an execution order thereof may be generated and processed to form one or more control instruction sets by control terminal(s), which may then be transmitted to individual smart lighting device(s) and/or to group(s) of the smart lighting devices.

For example, a first group including one or more smart lighting devices may be placed in a first room playing a first song (or any type of music), while a second group including one or more smart lighting devices may be placed in a second room playing a second song. Based on the collected audio information in each room, the lighting effect in each room may be different and may be coordinated in certain manner.

In addition, when switching songs in each room, the lighting effect in that room may also be controlled accordingly. The user may use the control terminal to define the lighting signals/adjustments associated with the music change. For example, a user may associate the new piece of music to a warmer or cooler color of light generated by one or more of smart lighting devices. In one example, a user may change to a new song, and may use the control terminal(s) to control and adjust a first lighting device to a warmer color of light (e.g., the lighting device in the kitchen) and a second lighting device to a cooler color of light (e.g., the lighting device in a study) while switching to a new song.

In another embodiment, the smart lighting devices (or the control terminal) may include sensors, such as motion sensors, temperature sensors, lighting sensors, temperature sensors, air quality sensors, etc. When information detected by these sensors being sent to the control terminal, the control terminal may process to provide control instruction set(s) to control lighting effects of corresponding smart lighting device(s).

In various embodiments, smart lighting device(s) may be controlled to provide a flashing light to indicate an abnormal condition of self or other devices.

In some embodiments, any suitable computer readable media can be used for storing instructions for performing the processes described herein. For example, in some embodiments, computer readable media can be transitory or non-transitory. For example, non-transitory computer readable media can include media such as magnetic media (e.g., hard disks, floppy disks, and/or any other suitable media), optical media (e.g., compact discs, digital video discs, Blu-ray discs, and/or any other suitable optical media), semiconductor media (e.g., flash memory, electrically programmable read only memory (EPROM), electrically erasable programmable read only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

The provision of the examples described herein (as well as clauses phrased as “such as,” “e.g.,” “including,” and the like) should not be interpreted as limiting the claimed subject matter to the specific examples; rather, the examples are intended to illustrate only some of many possible aspects.

Accordingly, a smart lighting device, a related control terminal, and a related lighting system are provided.

Although the disclosed subject matter has been described and illustrated in the foregoing illustrative embodiments, it is understood that the present disclosure has been made only by way of example, and that numerous changes in the details of embodiment of the disclosed subject matter can be made without departing from the spirit and scope of the disclosed subject matter, which is only limited by the claims which follow. Features of the disclosed embodiments can be combined and rearranged in various ways. Without departing from the spirit and scope of the disclosed subject matter, modifications, equivalents, or improvements to the disclosed subject matter are understandable to those skilled in the art and are intended to be encompassed within the scope of the present disclosure.

1-12. (canceled)

13. A control terminal, comprising:
an input unit, configured for receiving at least two control instructions, and an execution order of the at least two control instructions, wherein each of the at least two control instructions is used to instruct and control at least one smart lighting device;
a processing unit, connected with the input unit for encapsulating the at least two control instructions into a control instruction set, wherein the control instruction set includes the at least two control instructions and information of an execution order of the at least two control instructions; and
a radiofrequency (RF) unit, connected with the processing unit for transmitting the control instruction set to the at least one smart lighting device.

14. The control terminal of claim 13, wherein:
the input unit is configured to receive the at least two control instructions from user's sequential inputs; and
the execution order of the at least two control instructions is an order of the user's sequential inputs.

15. The control terminal of claim 13, wherein the execution order of the at least two control instructions is determined by a time sequence for performing the at least two control instructions.

16. The control terminal of claim 13, further comprising:
a memory unit for storing at least one control effect that corresponds to the at least two control instructions used to control the at least one smart lighting device to provide a lighting effect corresponding to the at least one control effect.

17. The control terminal of claim 16, wherein the input unit is further configured for:
receiving a user input indicating a control effect stored in the memory unit; and
determining the at least two control instructions, and the execution order of the at least two control instructions based on the control effect.

18. The control terminal of any one of claims 13, wherein:
the radiofrequency (RF) unit comprises a transmitter and a modulation circuit, wherein:
the modulation circuit is configured for modulating the control instruction set based on a preset modulation scheme to obtain a modulated control signal, and
the transmitter is connected with the modulation circuit for transmitting the modulated control signal wirelessly to the at least one smart lighting device.

19. A smart lighting device, comprising:
a radiofrequency unit, configured for receiving a control instruction set sent by a control terminal;
a processing unit, connected with the radiofrequency unit for parsing the control instruction set to obtain at least two control instructions and an execution order of the at least two control instructions;
a cache unit, connected with the processing unit for caching the at least two control instructions; and
a lighting module, connected with the cache unit and configured to control lighting according to the at least two control instructions, wherein:
the processing unit is configured to sequentially send the at least two control instructions to the cache unit according to the execution order, and
the cache unit is further configured to send the at least two control instructions in a first-in first-out order to the lighting module.

20. The smart lighting device of claim 19, wherein the cache unit is further configured to send the at least two control instructions one after another in the first-in first-out order at a preset time interval to the lighting module.

21. The smart lighting device of claim 19, wherein:
the processing unit is further configured to generate a clock according to execution time points in the at least two control instructions,
a clock edge of the clock is aligned with an execution time point, and
the cache unit is further configured for sending a control instruction to the lighting module in the first-in first-out order upon an upcoming clock edge of the clock.

22. The smart lighting device of claim 19, wherein:
the radiofrequency unit comprises a receiver and a demodulation circuit, wherein:
the receiver is configured for receiving a modulation signal transmitted wirelessly from the control terminal, and
the demodulation circuit is connected with the receiver for demodulating the modulation signal to obtain a control instruction set corresponding to the at least two control instructions.

23. A lighting system, comprising:
at least one control terminal according to claim 13; and
at least one smart lighting device according to claim 19.

24. The lighting system of claim 23, wherein the at least one control terminal is at least one of a mobile phone, a personal digital assistant, a personal computer, a home gateway, a wireless modems, a set-top box, a data card, and a wireless router.
